(19) United States
(12) Patent Application Publication
(10) Pub. No.: US 2026/0367736 A1
(43) Pub. Date: Nov. 19, 2026

(54) DISPLAY DEVICE AND METHOD OF PRODUCING DISPLAY DEVICE

(71) Applicant: Sharp Display technology Corporation, Kameyama City (JP)

(72) Inventor: Yuri MOTOMATSU, Kameyama City (JP)

(21) Appl. No.: 19/630,867

(22) Filed: Mar. 27, 2026

(30) Foreign Application Priority Data
May 15, 2025 (JP) 2025-081916

(51) Int. Cl. G06F 3/041; G02F 1/1333

(52) U.S. Cl. CPC G06F 3/04182; G02F 1/13338; G06F 2203/04107

(57) ABSTRACT

A display device includes a touch panel, a display panel having a first surface that is opposed to the touch panel and includes a display area displaying an image and a non-display area displaying no image, a conductive film disposed on the first surface and extending in the display area and the non-display area, at least two first conductive portions disposed in the non-display area on the first surface with a space therebetween and connected to the conductive film and having a sheet resistance lower than a sheet resistance of the conductive film, and a second conductive portion at least a portion of which is disposed in the non-display area on the first surface and connected to the at least two first conductive portions and grounded, the second conductive portion having a sheet resistance lower than the sheet resistance of the at least two first conductive portions.

### CROSS REFERENCE TO RELATED APPLICATION

This application claims priority from Japanese Patent Application No. 2025-81916 filed on May 15, 2025. The entire contents of the priority application are incorporated herein by reference.

### TECHNICAL FIELD

The technology described herein relates to a display device and a method of producing a display device with which a first conductive portion is easily formed and a shielding function is improved.

### BACKGROUND

There have been known display devices including touch panels. One example of such display devices is a touch screen panel liquid crystal device and the touch screen panel liquid crystal device includes a ground line that extends along an edge of an Indium Tin Oxide (ITO) layer formed in a shield layer and is for grounding the ITO layer. The shield layer is for shielding LCD noise that is caused in a liquid crystal display (LCD) and propagates toward a touch screen panel (TSP) sensor pattern. With such an arrangement, a resistance value difference according to a position of the ITO layer can be minimized. Accordingly, a noise shield function of the liquid crystal display can be improved.

Another example of the display devices includes a touch panel and the touch panel includes a detection region for generating a detection signal according to the contact position of a conductor, detection electrodes for outputting the detection signal generated in the detection region, a conductive frame covering an outside portion of the detection region and the detection electrodes from an upper side, and a shielding electrode formed on a portion of a CF substrate outside the detection region and between the detection electrodes. The shielding electrode is supplied with a shield signal for shielding an electric influence on the detection region and the detection electrodes. A distance between the shielding electrode and the detection region is shorter than a distance between the conductive frame and the detection region.

In the touch screen panel liquid crystal device of the one example, the ground line is connected to a flexible printed circuit board connection portion and grounded. In forming the ground line, the shield layer is covered by a mask having holes and subjected to sputtering through the mask and the ground line is formed. However, in the touch screen panel liquid crystal device of the one example, the ground line extends in a frame shape. Therefore, the mask is necessarily divided into several parts and it is difficult to form the ground line with sputtering.

The display device of the other example includes the shielding electrode that is supplied with a shield signal for shielding an electric influence on the detection region and the detection electrodes but does not include a structure corresponding to the ITO layer included in the touch screen panel liquid crystal device of the one example. Therefore, shielding of the detection region and the detection electrodes may be insufficient.

### SUMMARY

The technology described herein was made in view of the above circumstances. An object is to form a first conductive portion easily and improve a shielding function.
(1) A display device according to the technology described herein includes a touch panel, a display panel having a first surface that is opposed to the touch panel and includes a display area displaying an image and a non-display area displaying no image, a conductive film disposed on the first surface and extending in the display area and the non-display area, at least two first conductive portions disposed in the non-display area on the first surface with a space therebetween and connected to the conductive film and having a sheet resistance lower than a sheet resistance of the conductive film, and a second conductive portion at least a portion of which is disposed in the non-display area on the first surface and connected to the at least two first conductive portions and grounded, the second conductive portion having a sheet resistance lower than the sheet resistance of the at least two first conductive portions.
(2) In the display device, in addition to (1), the display panel may have a polygonal plan view shape and include corner portions and side portions on an outer edge of the display panel and the at least two first conductive portions may include first portions extending along the corner portions and may be arranged along one of the side portions with the space between the at least two first conductive portions.
(3) In the display device, in addition to (2), the second conductive portion may extend along the one of the side portions and mat be disposed to extend to overlap the at least two first conductive portions and the space.
(4) In the display device, in addition to (2) or (3), the at least two first conductive portions may include second portions that extend along the one of the side portions and continuously from the first portions, respectively, and the at least two first conductive portions may be arranged such that the second portions of the at least two first conductive portions are arranged with having the space therebetween.
(5) A method of producing a display device according to the technology described herein includes disposing a conductive film on a first surface of a display panel to extend in a display area and a non-display area of the display panel, the first surface being to be opposed to a touch panel, disposing first conductive portions in the non-display area on the first surface at intervals to be connected to the conductive film, the first conductive portions having a sheet resistance lower than a sheet resistance of the conductive film, and disposing a second conductive portion such that at least a portion of the second conductive portion is disposed in the non-display area on the first surface and connected to the first conductive portions and grounded, the second conductive portion having a sheet resistance lower than the sheet resistance of the first conductive portions.
(6) The method of producing a display device may further include, in addition to (5), in the disposing of the first conductive portions, disposing a mask plate that includes holes disposed at intervals in a portion overlapping the non-display area to be opposed to the first surface and disposing material of the first conductive portions on the first surface with sputtering through the mask plate.
(7) In the method of producing a display device, in addition to (6), the display panel may have a polygonal plan view shape and includes corner portions and side portions on an outer edge of the display panel, and the holes of the mask plate used in the disposing of the first conductive portions may include portions extending along the corner portions and may be arranged at intervals along the side portions and accordingly, the first conductive portions including first portions that extend along the corner portions may be disposed at intervals along the side portions.
(8) The method of producing a display device may further include, in addition to (6) or (7), preparing a display panel material member to be separated into multiple parts to be display panels including the display panel. The mask plate used in the disposing of the first conductive portions may have a size so as to overlap the display panel material member and may be disposed such that the holes overlap the non-display areas of the display panels.

According to the technology described herein, a first conductive portion is easily formed and a shielding function is improved.

### BRIEF DESCRIPTION OF THE DRAWINGS

FIG. 1 is a schematic cross-sectional view of a liquid crystal display device according to a first embodiment.

FIG. 2 is a cross-sectional view illustrating a connection portion of a conductive film, a first conductive portion, and a second conductive portion of the liquid crystal display device according to the first embodiment.

FIG. 3 is a plan view illustrating a liquid crystal panel, the conductive film, the first conductive portions, and the second conductive portions of the liquid crystal display device according to the first embodiment.

FIG. 4 is a cross-sectional view along iv-iv line in FIG. 3 illustrating the liquid crystal panel, the conductive film, the first conductive portions, and the second conductive portions according to the first embodiment.

FIG. 5 is a cross-sectional view along v-v line in FIG. 3 illustrating the liquid crystal panel, the conductive film, the first conductive portion, and the second conductive portion according to the first embodiment.

FIG. 6 is a plan view illustrating the liquid crystal panel, the conductive film, and the first conductive portions according to the first embodiment.

FIG. 7 is a cross-sectional view along vii-vii line in FIG. 6 illustrating the liquid crystal panel, the conductive film, and the first conductive portions according to the first embodiment.

FIG. 8 is a plan view of a liquid crystal panel material member produced through a liquid crystal panel producing process included in a method of producing the liquid crystal display device according to the first embodiment.

FIG. 9 is a plan view illustrating a mask plate used in a liquid crystal panel processing process included in the method of producing the liquid crystal display device according to the first embodiment.

FIG. 10 is a cross-sectional view illustrating the liquid crystal panel material member along x-x line in FIG. 9 and with a material member surface of the liquid crystal panel material member being processed with sputtering through the mask in the liquid crystal panel processing process included in the method of producing the liquid crystal display device according to the first embodiment and the first conductive portions being formed.

### DETAILED DESCRIPTION

### First Embodiment

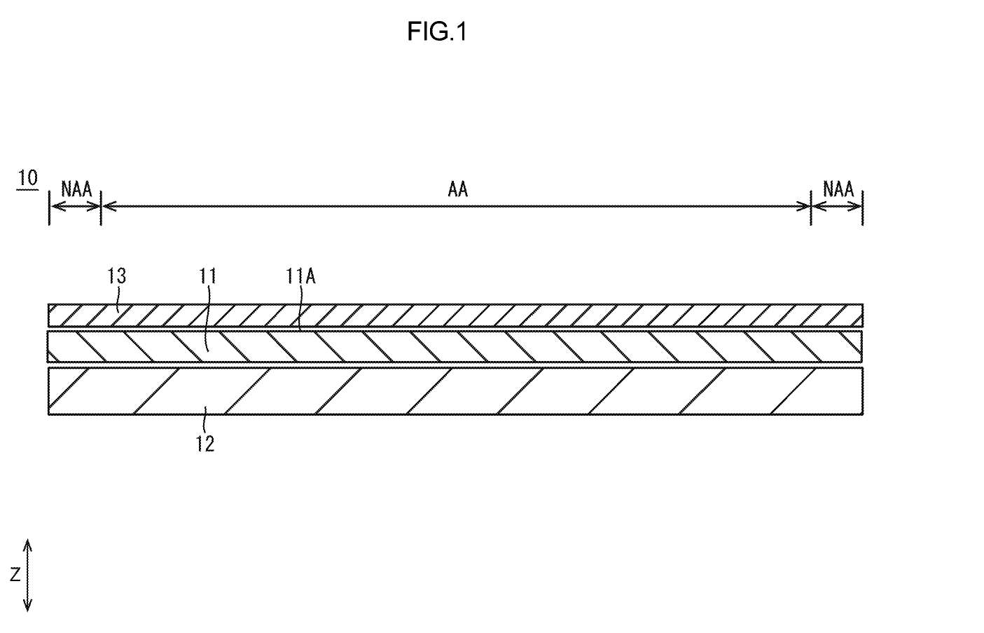

A first embodiment will be described with reference to FIGS. 1 - 10. A liquid crystal display device 10 (a display device) with an image display function and a touch panel function (a position input function) will be described. X-axes, Y-axes, and Z-axes may be present in the drawings. The axes in each drawing correspond to the respective axes in other drawings. An upper side and a lower side in FIGS. 1, 4, 5, 7, and 10 correspond to a front side and a back side of the liquid crystal display device 10, respectively.

As illustrated in FIG. 1, the liquid crystal display device 10 at least includes a liquid crystal panel 11 (a display panel) that displays an image, a backlight unit 12 (a lighting device) that supplies light to the liquid crystal panel 11 for displaying, and a touch panel 13 that detects positions of input performed by a user.

The liquid crystal panel 11 has a first surface 11A that is a front side surface opposite the touch panel 13 and is configured as a display surface. A middle section of the first surface 11A of the liquid crystal panel 11 is configured as a display area AA in which images are displayed. An outer section in a frame shape surrounding the display area AA in the first surface 11A of the liquid crystal panel 11 is configured as a non-display area NAA in which images are not displayed. Polarizing plates are attached to front and back surfaces of the liquid crystal panel 11. The backlight unit 12 is disposed behind (on a back surface side of) the liquid crystal panel 11. The backlight unit 12 includes a light source configured to emit white light (e.g., LEDs), optical members for converting the light from the light source into planar light by applying optical effects to the light from the light source, and a chassis where the light source and the optical members are disposed. The chassis is formed by bending a metal plate member (a metal plate) into a predetermined shape and configured as a casing of the backlight unit 12.

The touch panel 13 is disposed on a front side of the liquid crystal panel 11 and a back side surface of the touch panel 13 is opposed to the first surface 11A. The touch panel 13 is for detecting positions of input performed by a user based on the displayed images. The touch panel 13 uses a projection type electrostatic capacitance method and a mutual-capacitance method is used for detection, for instance. The touch panel 13 includes a touch panel pattern that is formed by patterning a light transmissive conductive film that is disposed on a substantially transparent substrate. The touch panel pattern is disposed to overlap the display area AA of the liquid crystal panel 11. Therefore, the display area AA of the liquid crystal panel 11 substantially corresponds to a touch area in which input positions are detectable (a position input area). The non-display area NAA substantially corresponds to a non-touch area in which input positions are not detectable (a non-position input area). When the user intends to input a position based on a displayed image that is displayed in the display area AA of the liquid crystal panel 11 and the user moves a finger or a touch pen that is an electrically conductive member closer to the surface of the touch panel 13, the finger or the touch pen and the touch panel pattern form an electrostatic capacitance. The positions of input performed by the user can be detected by detecting change in the amount of the electrostatic capacitance with a touch controller that is connected to the touch panel pattern.

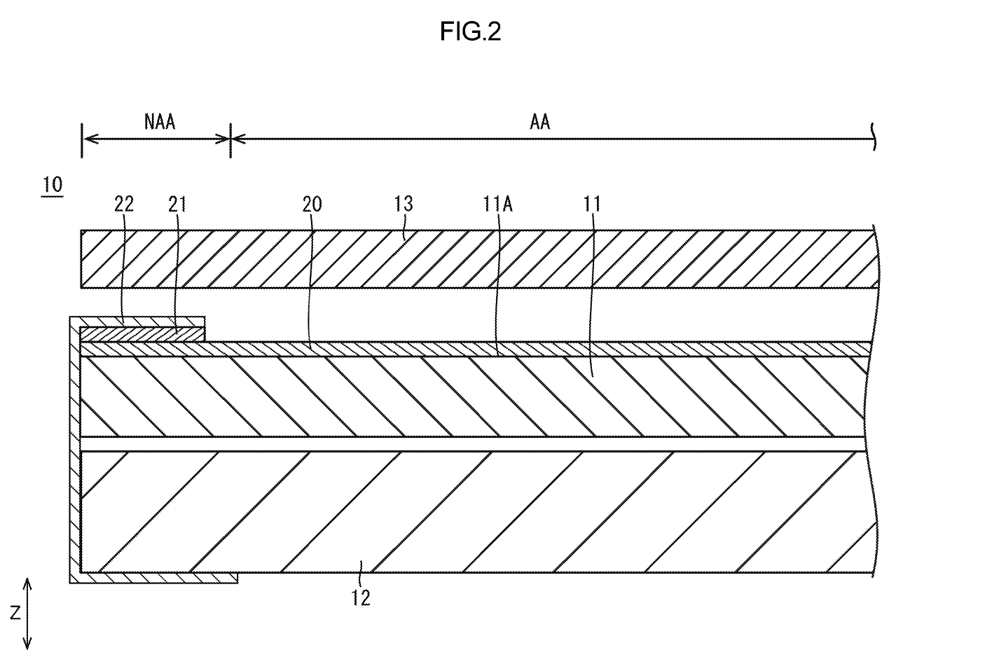

As illustrated in FIG. 2, a conductive film 20, a first conductive portion 21, and a second conductive portion 22 are disposed on the first surface 11A of the liquid crystal panel 11. The conductive film 20 is a transparent electrode film made of transparent electrode material such as indium tin oxide (ITO) and continuously extends in the display area AA and the non-display area NAA on the first surface 11A. The first conductive portion 21 is disposed in the non-display area NAA on the first surface 11A. The first conductive portion 21 is directly disposed on the conductive film 20 and connected to the conductive film 20. The first conductive portion 21 extends from an outer edge to an inner edge (a border of the display area AA and the non-display area NAA) of the non-display area NAA. The first conductive portion 21 is formed by disposing metal material such as silver on the first surface 11A with sputtering. The first conductive portion 21 has a sheet resistance lower than a sheet resistance of the conductive film 20.

As illustrated in FIG. 2, a portion of the second conductive portion 22 is disposed on the non-display area NAA on the first surface 11A and directly disposed on the first conductive portion 21 and connected to the first conductive portion 21. The second conductive portion 22 is an electrically conductive tape. The second conductive portion 22 includes a metal foil such as a copper foil and an aluminum foil and an adhesive layer coated on a surface of the metal foil. The adhesive layer includes conductive particles. The second conductive portion 22 has a sheet resistance lower than the sheet resistance of the first conductive portion 21. The second conductive portion 22 includes an extending portion that extends outside the first surface 11A. The extending portion of the second conductive portion 22 is bent at the outer edge of the liquid crystal panel 11 toward the back side and connected to the chassis. The second conductive portion 22 is physically fixed to and electrically connected to the first conductive portion 21 and the chassis of the backlight unit 12, which are targets to be connected, with the adhesive layer. Thus, the conductive film 20 is electrically connected to the chassis via the first conductive portion 21 and the second conductive portion 22 and grounded. With such a configuration, even if noise is caused in the liquid crystal panel 11, the noise is shielded by the conductive film 20 that continuously extends in the display area AA and the non-display area NAA on the first surface 11A. Particularly, in this embodiment, the sheet resistance of the first conductive portion 21 is lower than the sheet resistance of the conductive film 20 and the sheet resistance of the second conductive portion 22 is lower than the sheet resistance of the first conductive portion 21. Therefore, a contact resistance of the conductive film 20 and the first conductive portion 21 can be effectively reduced and a contact resistance of the first conductive portion 21 and the second conductive portion 22 can be effectively reduced. Accordingly, the shielding function is improved and the operation of the touch panel 13 that is opposed to the first surface 11A is less likely to be adversely affected by the noise.

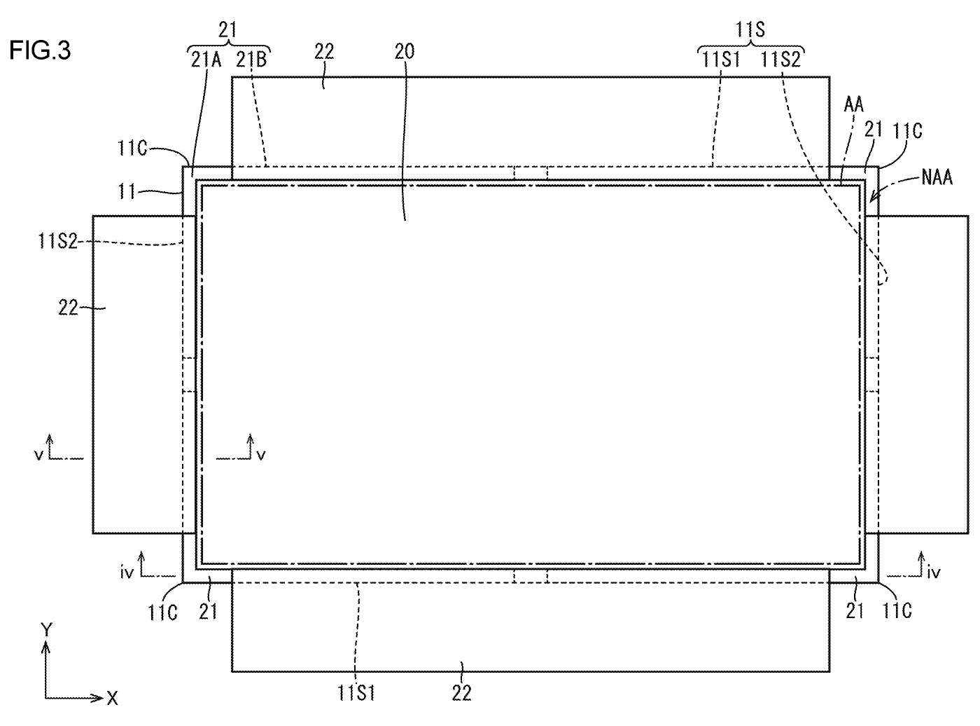

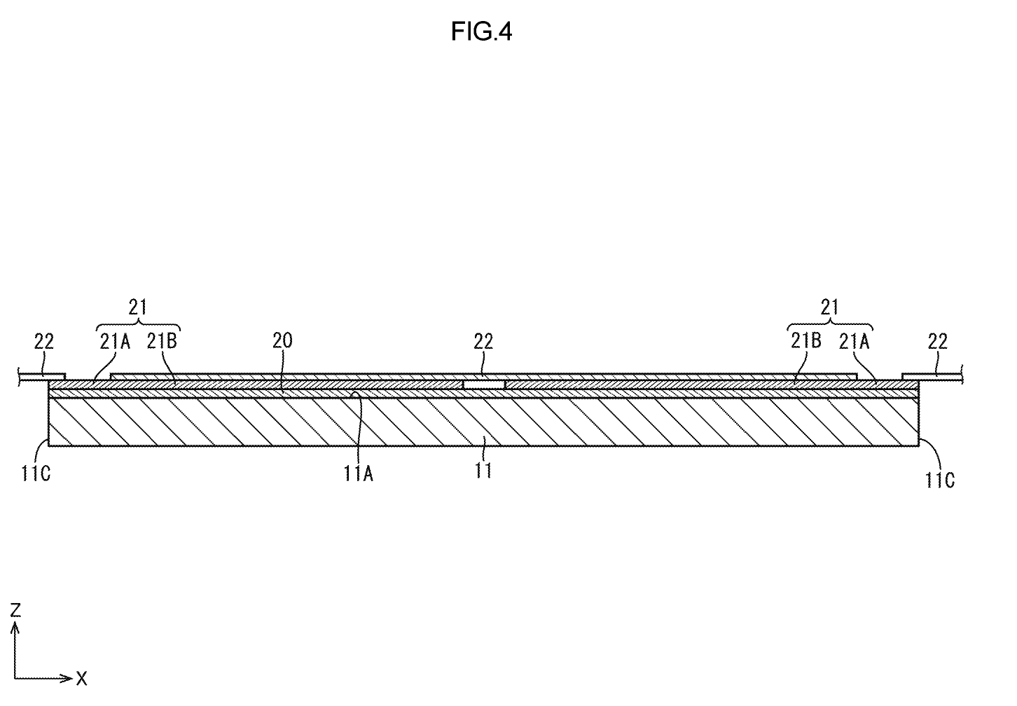

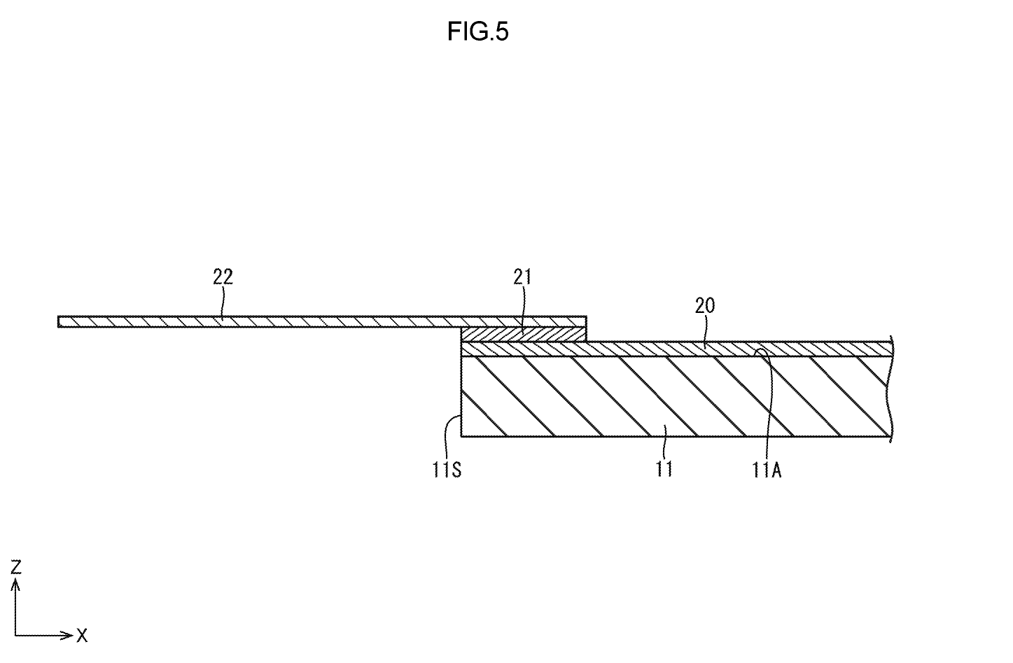

As illustrated in FIG. 3, the liquid crystal panel 11 has a laterally long rectangular (polygonal) plan view shape. The liquid crystal panel 11 has an outer edge including four corner portions 11C and four side portions 11S. The four side portions 11S include two long side portions 11S1 extending along the X-axis direction and two short side portions 11S2 extending along the Y-axis direction. The corner portion 11C is formed by an end portion of the long side portion 11S1 and an end portion of the short side portion 11S2 (two side portions 11S) that crosses the long side portion 11S1. FIGS. 3 - 5 illustrate the liquid crystal panel 11 where the conductive film 20, the first conductive portions 21, and the second conductive portions 22 are disposed and before the backlight unit 12 and the touch panel 13 are attached. In FIGS. 3 - 5, the second conductive portion 22 is in an unfolded state (before being folded). As illustrated in FIGS. 3 - 5, the conductive film 20 is disposed in a substantially entire area of the first surface 11A of the liquid crystal panel 11. As illustrated in FIGS. 3 and 4, the second conductive portions 22 extend along the respective side portions 11S of the liquid crystal panel 11 and have lengths that are shorter than corresponding lengths of the side portions 11S. The second conductive portion 22 is disposed to cover a portion of the side portion 11S except for end portions thereof (the corner portions 11C) and not to overlap the corner portions 11C. As illustrated in FIG. 5, with the second conductive portion 22 being disposed on the liquid crystal panel 11 and in the unfolded state, the extending portion of the second conductive portion 22 extends outward from the outer edge of the liquid crystal panel 11. The extending portion is folded toward the back surface side after the backlight unit 12 is attached to the liquid crystal panel 11.

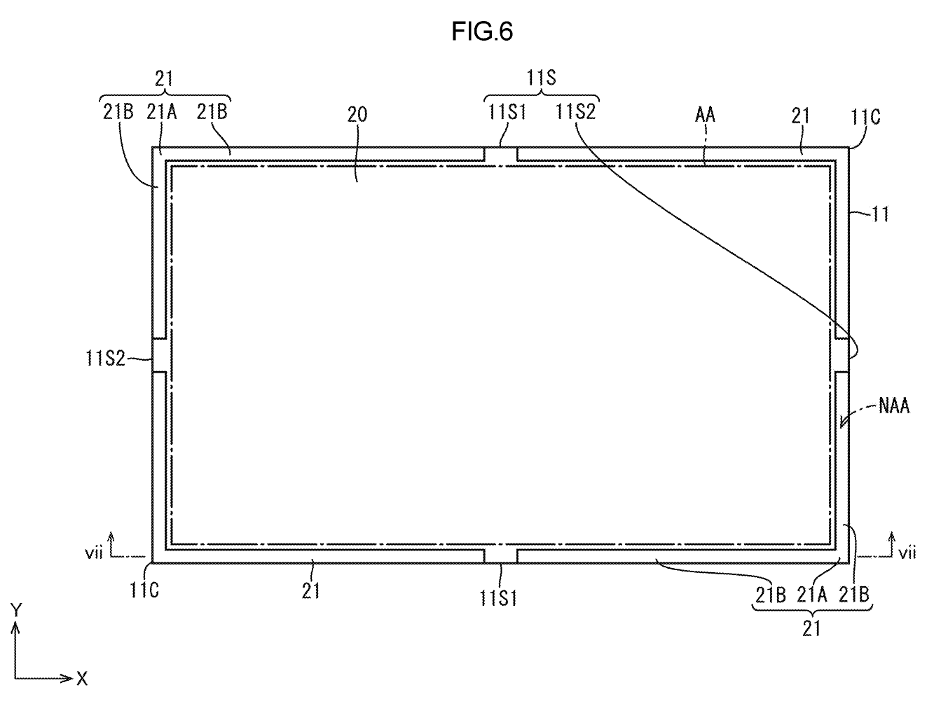

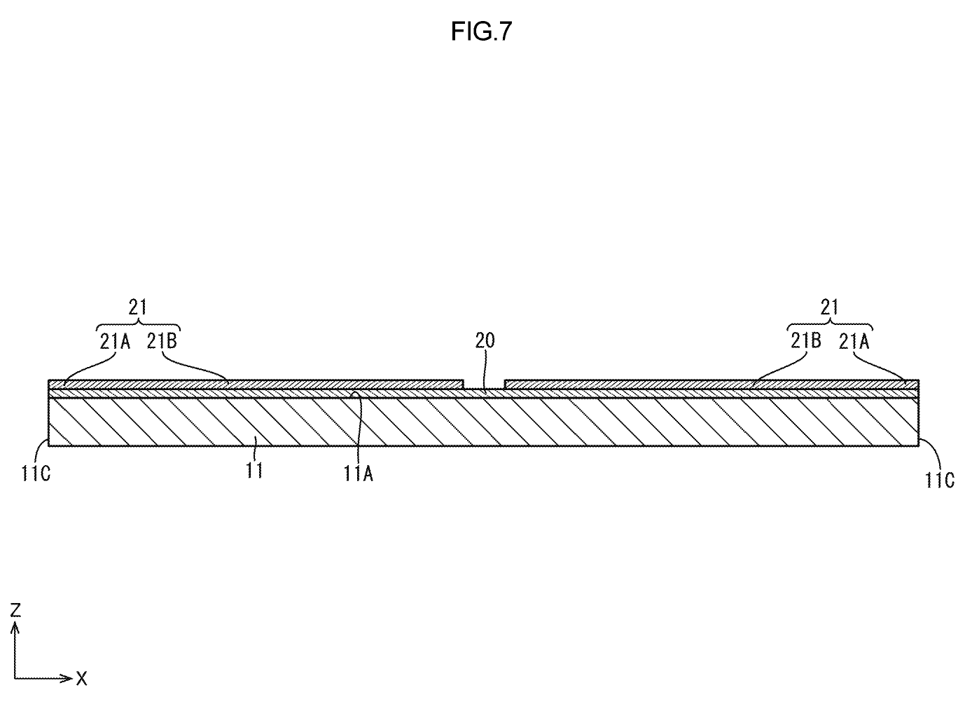

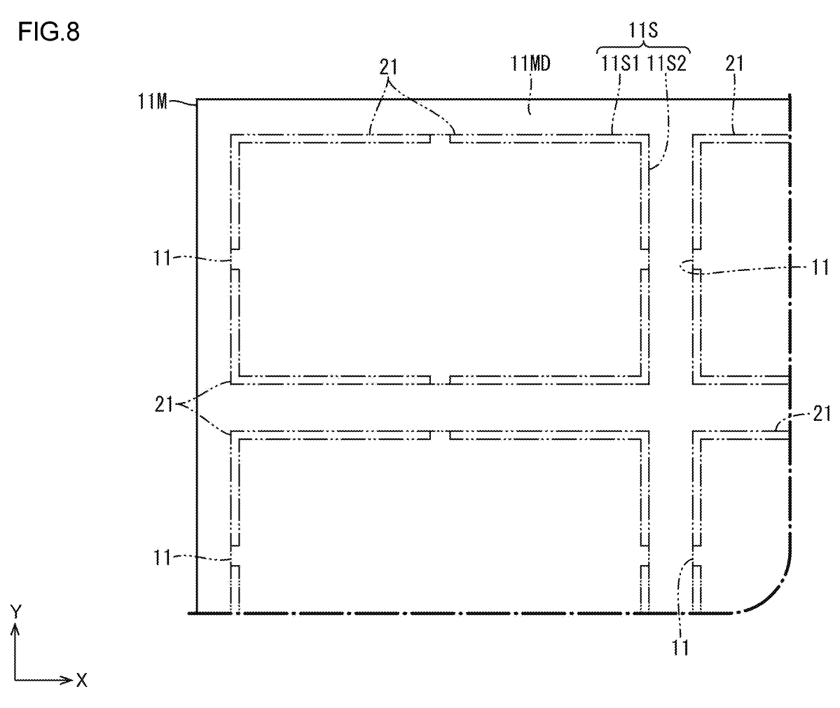

A configuration of the first conductive portion 21 will be described with reference to FIGS. 6 and 7. FIGS. 6 and 7 illustrate the liquid crystal panel 11 before the second conductive portions 22 being disposed. As illustrated in FIGS. 6 and 7, the first conductive portions 21 are arranged at intervals in the non-display area NAA. In the process of producing the liquid crystal display device 10 of this embodiment, the first conductive portions 21 are mounted on the liquid crystal panel 11 as follows. The first surface 11A of the liquid crystal panel 11 is covered by a mask plate 30 having holes 30A and subjected to sputtering through the mask plate 30 and thus, the first conductive portions 21 are formed (refer to FIGS. 8 -10). As previously described, the first conductive portions 21 are arranged at intervals in the non-display area NAA. Therefore, the mask plate 30 that is used in the production process is not necessarily divided into several parts. Accordingly, the size of the holes 30A of the mask plate 30 can be same. Therefore, the first conductive portions 21 can be easily formed and the method is preferable for mass production.

As illustrated in FIG. 6, the first conductive portions 21 include first portions 21A that extend along the corner portions 11C. The first conductive portions 21 are arranged at intervals along the side portions 11S. If the first conductive portion has a shape extending only along the side portion 11S, it is difficult to connect the second conductive portion 22 to the first conductive portion 21 near the corner portion 11C of the liquid crystal panel 11. In this respect, the first conductive portion 21 includes the first portion 21A that extends along the corner portion 11C and the first conductive portions 21 are arranged at intervals along the side portion 11S. Therefore, as illustrated in FIG. 3, the second conductive portion 22 can be connected to the first conductive portions 21 easily at portions that do not overlap the corner portions 11C of the liquid crystal panel 11.

As illustrated in FIG. 6, each of the first conductive portions 21 includes the first portion 21A and second portions 21B that extend from the first portion 21A along the side portions 11S. Specifically, the first conductive portion 21 includes the second portion 21B extending along the long side portion 11S1 (the X-axis direction) and the second portion 21B extending along the short side portion 11S2 (the Y-axis direction). The two second portions 21B are continuous to the first portion 21A. The first conductive portion 21 has a substantially L-shape as a whole. The adjacent first conductive portions 21 are arranged such that the second portions 21B of the respective adjacent first conductive portions 21 are arranged with a space therebetween. The space between the two adjacent second portions 21B is disposed in a middle of the side portion 11S. Specifically, the two first conductive portions 21 arranged in the X-axis direction are disposed such that the second portions 21B extending along the long side portion 11S1 are arranged with a space in a middle of the long side portion 11S1. The two first conductive portions 21 arranged in the Y-axis direction are disposed such that the second portions 21B extending along the short side portion 11S2 are arranged with a space in a middle of the short side portion 11S2. With such a configuration, the portion of the liquid crystal panel 11 corresponding to the space between the two adjacent second portions 21B of the two adjacent first conductive portions 21 arranged next to each other can be effectively away from the corner portion 11C of the liquid crystal panel 11. Accordingly, the second conductive portion 22 can be connected to the first conductive portions 21 more easily.

As illustrated in FIGS. 3 and 4, the second conductive portions 22 extend along the side portions 11S, respectively. The second conductive portion 22 extends continuously to overlap the two adjacent first conductive portions 21 that are arranged with a space. Specifically, the second conductive portion 22 is disposed to be contacted with (overlap) the second portions 21B of the two adjacent first conductive portions 21 arranged with a space and covers the portion of the liquid crystal panel 11 corresponding to the space between the second portions 21B from an upper layer side. Namely, the portion of the liquid crystal panel 11 corresponding to the space between the two first conductive portions 21 arranged with a space along the side portion 11S can be shielded by the second conductive portion 22 that extends to overlap the two first conductive portions 21 and the space. Accordingly, the shielding function can be further improved. The second conductive portion 22 is not contacted with (does not overlap) the first portions 21A of the first conductive portion 21 (refer to FIGS. 3 and 4).

The present embodiment has the configuration previously described and a method of producing the liquid crystal display device 10 will be described. The method of producing the liquid crystal display device 10 at least includes a liquid crystal panel producing process of producing the liquid crystal panel 11, a liquid crystal panel processing process in which the conductive film 20, the first conductive portions 21, and the second conductive portions 22 are disposed on the liquid crystal panel 11, a backlight producing process of producing the backlight unit 12, a touch panel producing process of producing the touch panel 13, and a joining process of joining together the liquid crystal panel 11, the backlight unit 12, and the touch panel 13.

In the liquid crystal panel producing process, as illustrated in FIG. 8, large size mother glasses are bonded and a liquid crystal panel material member 11M (a display panel material member) including the liquid crystal panels 11 is produced. In FIG. 8, the first conductive portions 21, which are to be disposed on the liquid crystal panels 11, are illustrated with two-dot chain line.

In the liquid crystal panel processing process, the conductive film 20 and the first conductive portions 21 are sequentially disposed on the liquid crystal panel material member 11M, which is produced through the liquid crystal panel producing process. Then, the liquid crystal panel material member 11M is divided and separated into the liquid crystal panels 11 and the second conductive portions 22 are mounted on each of the liquid crystal panels 11. The liquid crystal panel material member 11M includes the liquid crystal panels 11 and a disposal panel portion 11MD that is a portion outside the liquid crystal panels 11. The disposal panel portion 11MD is to be disposed of after the separation of the liquid crystal panels 11. The disposal panel portion 11MD has a plan view shape of a grid. The conductive film 20 is disposed on the entire area of the material member surface 11MA (including the first surfaces 11A) of the liquid crystal material member 11M.

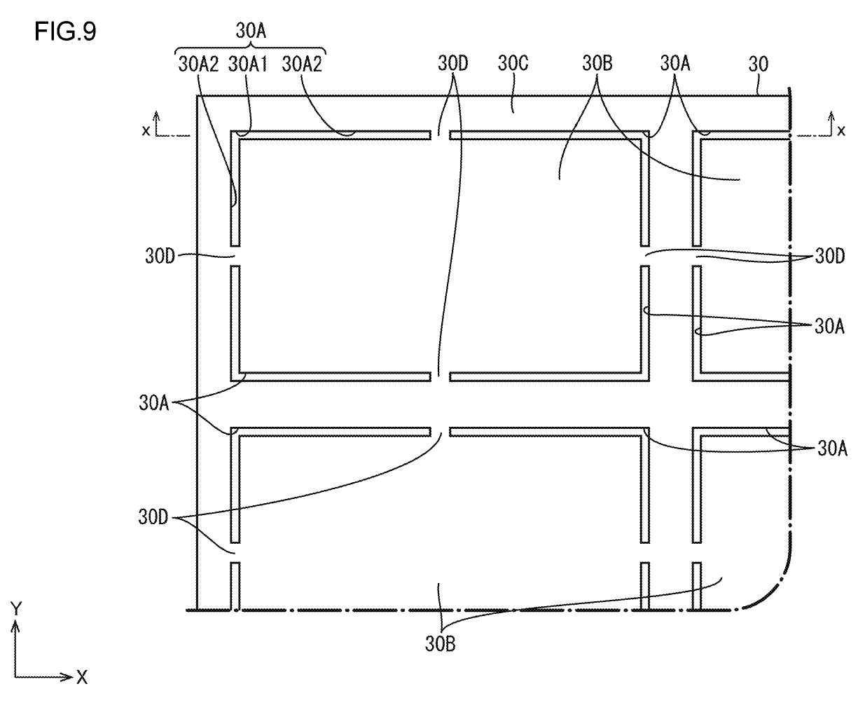

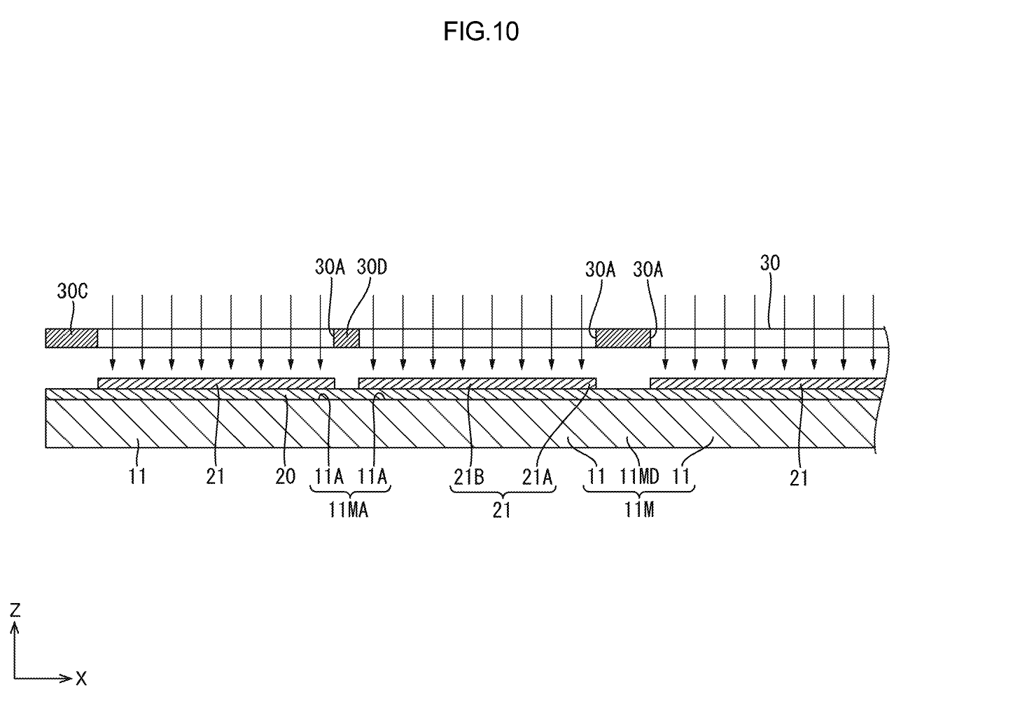

The process of disposing the first conductive portions 21 on the liquid crystal panel material member 11M will be described in detail. The first conductive portions 21 are formed on the conductive film 20 with disposing metal material on the material member surface 11MA of the liquid crystal panel material member 11M with sputtering. The mask plate 30 illustrated in FIGS. 9 and 10 is used to form the first conductive portions 21 with sputtering. The mask plate 30 is for selectively masking portions of the liquid crystal panel material member 11M where the first conductive portions 21 are not to be formed. The mask plate 30 has a size substantially same as the size of the liquid crystal panel material member 11M and is disposed to overlap an entire area of the liquid crystal panel material member 11M.

As illustrated in FIG. 9, the mask plate 30 includes holes 30A. The holes 30A have a non-circular plan view shape. The holes 30A are formed at intervals in the non-display areas NAA of the liquid crystal panels 11 included in the liquid crystal panel material member 11M. The hole 30A includes a first hole portion 30A1 that extends along the corner portion 11C of the liquid crystal panel 11 and two second hole portions 30A2 that extend along the side portions 11S of the liquid crystal panel 11. The hole 30A has a L-shape in a plan view. One of the two second hole portions 30A2 extends along the long side portion 11S1 (the X-axis direction) and the other one of the two second hole portions 30A2 extends along the short side portion 11S2 (the Y-axis direction). The holes 30A are arranged at intervals in the directions in which the side portions 11S extend (the X-axis direction and the Y-axis direction).

As illustrated in FIG. 9, the mask plate 30 includes first mask portions 30B, a second mask portion 30C, and third mask portions 30D. Each of the first mask portions 30B is a portion of the mask plate 30 that is inside and surrounded by the holes 30A and the first mask portions 30B, respectively, overlap the display areas AA of the liquid crystal panels 11 included in the liquid crystal panel material member 11M. The second mask portion 30C is a portion of the mask plate 30 outside the holes 30A and overlaps the disposal panel portion 11MD of the liquid crystal panel material member 11M. Each of the third mask portions 30D is a portion of the mask plate 30 that is between every two holes 30A that are arranged along the side portion 11S. The third mask portion 30D connects the first mask portion 30B and the second mask portion 30C. With such a configuration, the mask plate 30 is not necessarily separated into multiple parts and the plan view size of the holes 30A can be made same.

As illustrated in FIG. 10, when forming the first conductive portions 21, the mask plate 30 is disposed above the liquid crystal panel material member 11M to be opposed to (overlap) the material member surface 11MA (the first surfaces 11A). Subsequently, metal material of the first conductive portions 21 is supplied to the mask plate 30 from above and is disposed on the material member surface 11MA with sputtering. The metal material is disposed on the conductive film 20 on the material member surface 11MA through the holes 30A of the mask plate 30 and portions of the material member surface 11MA that do not overlap the holes 30A are covered by the mask plate 30. Accordingly, the first conductive portions 21 are collectively formed on the portions of the material member surface 11MA overlapping the holes 30A of the mask plate 30 at the same time. The first conductive portions 21, which are formed with the above method, include the first portions 21A and the second portions 21B and are disposed at intervals in the non-display areas of the liquid crystal panels 11 along the side portions 11S. Portions of the liquid crystal panel material member 11M corresponding to the display areas AA of the liquid crystal panels 11 are covered by the first mask portions 30B of the mask plate 30 and therefore, the first conductive portions 21 are not formed on the portions corresponding to the display areas AA. The disposal panel portion 11MD of the liquid crystal panel material member 11M is covered by the second mask portion 30C of the mask plate 30 and therefore, the first conductive portions 21 are not formed on the disposal panel portion 11MD. Portions of the liquid crystal panel material member 11M corresponding to portions between the first conductive portions 21 that are arranged at intervals along the side portions 11S are covered by the third mask portions 30D of the mask plate 30 and therefore, the first conductive portions 21 are not formed. As previously described, in this embodiment, the first conductive portions 21 are formed with using the mask plate 30 that has a non-separated structure as illustrated in FIG. 9. Therefore, the liquid crystal panels 11 can be produced with high production efficiency.

After the first conductive portions 21 are formed as described above, the liquid crystal panel material member 11M is divided and separated into the liquid crystal panels 11. In this process, the disposal panel portion 11MD is disposed of. Thereafter, the second conductive portions 22 are formed on the liquid crystal panels 11. The second conductive portions 22 are positioned with respect to and disposed on the liquid crystal panels 11 such that a middle of each second conductive portion 22 with respect to the length direction substantially matches a middle of each side portion 11S of the liquid crystal panels 11. The second conductive portions 22 are disposed to be contacted with (overlap) the adjacent second portions 21B of the two respective first conductive portions 21 that are arranged at intervals and cover the portions between the adjacent second portions 21B from above. Therefore, the second conductive portions 22 are not disposed on portions of the liquid crystal panel 11 near the corner portions 11C. The first portions 21A of the first conductive portions 21 are disposed on the portions of the liquid crystal panel 11 near the corner portions 11C. Thus, one of or both of the first conductive portion 21 and the second conductive portion 22 extends to cover an entire periphery of the outer edge portion of the liquid crystal panel 11. There is no area in the outer edge portion of the liquid crystal panel 11 where only the conductive film 20 is disposed. Therefore, a high shielding function can be exerted. If each of the first conductive portions 21 is configured to include only the second portion 21B extending along the side portion 11S, it is difficult to connect the second conductive portion 22 to the first conductive portion 21 near the corner portion 11C of the liquid crystal panel 11. In this respect, according to this embodiment, the first conductive portions 21 include the first portions 21A extending along the corner portion 11C and are arranged at intervals along the side portions 11S. Therefore, the second conductive portion 22 can be easily connected to the first conductive portions 21 with avoiding the corner portions 11C of the liquid crystal panel 11.

As previously described, the liquid crystal display device 10 (the display device) of this embodiment includes the touch panel 13, the liquid crystal panel 11 (the display panel), the conductive film 20, the first conductive portions 21, and the second conductive portions 22. The liquid crystal panel 11 includes the first surface 11A opposed to the touch panel 13. The first surface 11A includes the display area AA displaying an image and the non-display area NAA displaying no image. The conductive film 20 is disposed on the first surface 11A and extends continuously in the display area AA and the non-display area NAA. The first conductive portions 21 are disposed on the first surface 11A and in the non-display area NAA. The first conductive portions 21 are connected to the conductive film 20 and has a sheet resistance lower than the sheet resistance of the conductive film 20. At least portions of the second conductive portions 22 are disposed on the first surface 11A and in the non-display area NAA. The second conductive portions 22 are connected to the first conductive portions 21 and grounded and have a sheet resistance lower than the sheet resistance of the first conductive portions 21. The first conductive portions 21 are arranged at intervals in the non-display area NAA.

Even if a noise is caused in the liquid crystal panel 11, the noise can be shielded by the conductive film 20 that extends in the display area AA and the non-display area NAA on the first surface 11A. Accordingly, the shielding function is improved and the operation of the touch panel 13 that is opposed to the first surface 11A is less likely to be adversely affected by the noise. The conductive film 20 is connected to the second conductive portions 22, which has a lower sheet resistance than the first conductive portions 21, via the first conductive portions 21, which has a lower sheet resistance than the conductive film 20, in the non-display area NAA. Accordingly, the conductive film 20 is grounded with a low contact resistance. When disposing the first conductive portions 21 in the producing process, the first surface 11A of the liquid crystal panel 11 is covered by the mask plate 30 having the holes 30A with masking and the first surface 11A is processed with sputtering through the mask plate 30. Thus, the first conductive portions 21 may be formed. The first conductive portions 21 are disposed at intervals in the non-display area NAA. Therefore, the mask plate 30 used in the producing process is not necessarily separated into multiple parts. Therefore, the size of the holes 30A of the mask plate 30 can be made same and the first conductive portions 21 can be easily formed. The producing method is particularly preferable for mass production.

The liquid crystal panel 11 has a polygonal plan view shape. The liquid crystal panel 11 includes the corner portions 11C and the side portions 11S on the outer edge thereof. Each of the first conductive portions 21 includes the first portion 21A that extends along the corner potion 11C and the first conductive portions 21 are arranged at intervals along the side portions 11S. If each of the first conductive portions 21 is configured to include only the second portion 21B extending along the side portion 11S, it is difficult to connect the second conductive portion 22 to the first conductive portion 21 near the corner portion 11C of the liquid crystal panel 11. In this respect, according to this embodiment, the first conductive portions 21 include the first portions 21A extending along the corner portions 11C and are arranged at intervals along the side portions 11S. Therefore, the second conductive portion 22 can be easily connected to the first conductive portions 21 with avoiding the corner portions 11C of the liquid crystal panel 11.

Each of the second conductive portion 22 extends along the side portions 11S and is disposed to overlap the two adjacent first conductive portions 21 and the space therebetween. The portions of the liquid crystal panel 11 between every two adjacent first conductive portions 21 that are arranged at an interval along the side portion 11S can be shielded by the second conductive portions 22 that extend to overlap the two adjacent first conductive portions 21 and the space therebetween. This further improves the shielding function.

Each of the first conductive portions 21 includes the second portions 21B that extend along the side portions 11S and are continuous to the first portion 21A. The first conductive portions 21 are arranged such that the second portions 21B are arranged at intervals. The second portions 21B of the first conductive portions 21 are arranged along the side portion 11S with a space between the two second portions 21B of the respective two adjacent first conductive portions 21. Therefore, the portion of the liquid crystal panel 11 corresponding to the space between the two second portions 21B can be effectively away from the corner portion 11C of the liquid crystal panel 11. Accordingly, the second conductive portion 22 can be connected to the first conductive portions 21 more easily.

The method of producing the liquid crystal display device 10 according to this embodiment is for producing the liquid crystal display device 10 including the touch panel 13 and the liquid crystal panel 11 having the first surface 11A that is opposed to the touch panel 13 and has the display area AA displaying an image and the non-display area NAA displaying no image. In the method of producing the liquid crystal display device 10, the conductive film 20 extending in the display area AA and the non-display area NAA is disposed on the first surface 11A, the first conductive portions 21 having a sheet resistance lower than a sheet resistance of the conductive film 20 are disposed at intervals in the non-display area NAA on the first surface 11A so as to be connected to the conductive film 20, and the second conductive portions 22 having a sheet resistance lower than the sheet resistance of the first conductive portions 21 are disposed in the non-display area NAA on the first surface 11A so as to be connected to the first conductive portions 21 and grounded.

Even if a noise is caused in the liquid crystal panel 11, the noise can be shielded by the conductive film 20 that extends in the display area AA and the non-display area NAA on the first surface 11A. Accordingly, the shielding function is improved and the operation of the touch panel 13 that is opposed to the first surface 11A is less likely to be adversely affected by the noise. The conductive film 20 is connected to the second conductive portions 22 having a lower sheet resistance than the first conductive portions 21 via the first conductive portions 21 having a lower sheet resistance than the conductive film 20 in the non-display area NAA. Accordingly, the conductive film 20 is grounded with a low contact resistance. When disposing the first conductive portions 21 in the producing process, the first surface 11A of the liquid crystal panel 11 is covered by the mask plate 30 having the holes 30A with masking and the first surface 11A is processed with sputtering through the mask plate 30. Thus, the first conductive portions 21 may be formed. The first conductive portions 21 are disposed at intervals in the non-display area NAA. Therefore, the mask plate 30 used in the producing process is not necessarily separated into multiple parts. Therefore, the size of the holes 40A of the mask plate 30 can be made same and the first conductive portions 21 can be easily formed. The producing method is particularly preferable for mass production.

when forming the first conductive portions 21, the mask plate 30 is disposed to be opposed to the first surface 11A. The mask plate 30 includes the holes 30A that are arranged at intervals in a portion overlapping the non-display area NAA. The material of the first conductive portions 21 are disposed on the first surface 11A with sputtering through the mask plate 30. With the mask plate 30 being disposed to be opposed to the first surface 11A of the liquid crystal panel 11, the material of the first conductive portions 21 are disposed on the first surface 11A with sputtering through the mask plate 30. Then, the portions of the first surface 11A that do not overlap the holes 30A of the mask plate 30 are covered by the mask plate 30 with masking and the material of the first conductive portions 21 is disposed on the portions of the first surface 11A overlapping the holes 30A of the mask plate 30 with sputtering through the holes 30A. Accordingly, the first conductive portions 21 are selectively formed on the portions of the first surface 11A overlapping the holes 30A of the mask plate 30. The mask plate 30 is configured to have the holes 30A arranged at intervals and the holes 30A do not have a ring shape. Therefore, the mask plate 30 is not separated into multiple parts and has a non-separated structure.

The liquid crystal panel 11 has a polygonal plan view shape. The liquid crystal panel 11 includes the corner portions 11C and the side portions 11S on the outer edge thereof. When disposing the first conductive portions 21, the mask plate 30 including the holes 30A that extend along the corner portions 11C and are arranged at intervals along the side portions 11S is used. Accordingly, the first conductive portions 21 that include the first portions 21A extending along the corner potions 11C are formed to be arranged at intervals along the side portions 11S. With the material of the first conductive portions 21 being disposed on the first surface 11A with sputtering through the mask plate 30, the first conductive portions 21 including the first portions 21A are formed. The first portions 21A are formed though the portions of the holes 30A extending along the corner portions 11C. The first conductive portions 21 are formed at intervals along the side portions 11S. If the first conductive portion 21 is configured to include only the portion extending along the side portion 11S, it is difficult to connect the second conductive portion 22 to the first conductive portion 21 near the corner portion 11C of the liquid crystal panel 11. In this respect, according to this embodiment, the first conductive portion 21 includes the first portion 21A extending along the corner portion 11C and the first conductive portions 21 are arranged at intervals along the side portions 11S. Therefore, the second conductive portion 22 can be easily connected to the first conductive portions 21 with avoiding the corner portions 11C of the liquid crystal panel 11.

The liquid crystal panels 11 are produced by dividing the liquid crystal panel material member 11M (the display material member) including the liquid crystal panels 11 into multiple parts. When forming the first conductive portions 21, the mask plate 30 having a size so as to overlap the liquid crystal panel material member 11M and including the holes 30A in portions overlapping the non-overlapping areas NAA of the liquid crystal panels 11 is used. With the mask plate 30 being disposed to overlap the liquid crystal panel material member 11M, the material of the first conductive portions 21 is disposed on the first surfaces 11A of the liquid crystal panels 11 included in the liquid crystal panel material member 11M with sputtering through the mask plate 30. The mask plate 30 includes the holes 30A overlapping the non-display areas NAA of the liquid crystal panels 11. Therefore, the first conductive portions 21 are collectively formed on the non-overlapping display area NAA of each liquid crystal panel 11. The mask plate 30 having a size so as to overlap the liquid crystal panel material member 11M is not separated into several parts and is configured to have a non-separated structure. Therefore, the liquid crystal panels 11 can be produced with high production efficiency.

### Other Embodiments

The technology described herein is not limited to the embodiments described above and illustrated by the drawings. For example, the following embodiments will be included in the technical scope of the present technology.
(1) The number of first conductive portions 21 included in the liquid crystal panel 11 may be greater or smaller than four. Similarly, the number of second conductive portions 22 included in the liquid crystal panel 11 may be greater or smaller than four.
(2) The first conductive portions 21 may include first conductive portions including only the first portions 21A and first conductive portions including only the second portions 21B. Namely, the first portions 21A configured as the first conductive portions and the second portions 21B configured as the first conductive portions may be arranged at intervals.
(3) The plan view shape of the liquid crystal panels 11 may be a triangle, a vertically long rectangle, a trapezoid, a diamond, a parallelogram, and a polygonal shape such as a pentagon. The number and the arrangement of the corner portions 11C and the side portions 11S may be altered according to the plan view shape of the liquid crystal panel 11 and accordingly, the number and the arrangement of the first conductive portions 21 and the second conductive portions may be altered.
(4) The second conductive portions 22 may be connected to a conductive member other than the chassis of the backlight unit 12 (for instance, a holding member for holding the liquid crystal panel 11 and the backlight unit 12 and a holding member for holding the liquid crystal panel 11, the backlight unit 12, and the touch panel 13) and grounded.
(5) In the method of producing the liquid crystal display device 10, the liquid crystal panel material member 11M may be separated into the liquid crystal panels 11 before disposing the first conductive portions 21. In such a method, the mask plate 30 used for disposing the first conductive portions 21 may have a size overlapping one liquid crystal panel 11. The liquid crystal panel material member 11M may be divided into the liquid crystal panels 11 before disposing the conductive film 20.
(6) The detection method of the touch panel pattern of the touch panel 13 may be a self-capacitance method other than the mutual-capacitance method. The touch panel pattern may use an electrostatic capacitance method other than the projection type electrostatic capacitance method. The touch panel pattern may be a resistive touch panel, an ultrasonic touch panel, and an optical touch panel other than panels of the electrostatic capacitance method.
(7) Display panels other than the liquid crystal panel 11 may be used. In a configuration including a self-emission type display panel, the backlight unit 12 may not be included.

1. A display device comprising:
a touch panel;
a display panel having a first surface that is opposed to the touch panel and includes a display area displaying an image and a non-display area displaying no image;
a conductive film disposed on the first surface and extending in the display area and the non-display area;
at least two first conductive portions disposed in the non-display area on the first surface with a space therebetween and connected to the conductive film and having a sheet resistance lower than a sheet resistance of the conductive film; and
a second conductive portion at least a portion of which is disposed in the non-display area on the first surface and connected to the at least two first conductive portions and grounded, the second conductive portion having a sheet resistance lower than the sheet resistance of the at least two first conductive portions.

2. The display device according to claim 1, wherein
the display panel has a polygonal plan view shape and includes corner portions and side portions on an outer edge of the display panel, and
the at least two first conductive portions include first portions extending along the corner portions and are arranged along one of the side portions with the space between the at least two first conductive portions.

3. The display device according to claim 2, wherein the second conductive portion extends along the one of the side portions and is disposed to extend to overlap the at least two first conductive portions and the space.

4. The display device according to claim 2, wherein
the at least two first conductive portions include second portions that extend along the one of the side portions and continuously from the first portions, respectively, and
the at least two first conductive portions are arranged such that the second portions of the at least two first conductive portions are arranged with having the space therebetween.

5. A method of producing a display device comprising:
disposing a conductive film on a first surface of a display panel to extend in a display area and a non-display area of the display panel, the first surface being to be opposed to a touch panel;
disposing first conductive portions in the non-display area on the first surface at intervals to be connected to the conductive film, the first conductive portions having a sheet resistance lower than a sheet resistance of the conductive film; and
disposing a second conductive portion such that at least a portion of the second conductive portion is disposed in the non-display area on the first surface and connected to the first conductive portions and grounded, the second conductive portion having a sheet resistance lower than the sheet resistance of the first conductive portions.

6. The method of producing a display device according to claim 5, further comprising, in the disposing of the first conductive portions, disposing a mask plate that includes holes disposed at intervals in a portion overlapping the non-display area to be opposed to the first surface and disposing material of the first conductive portions on the first surface with sputtering through the mask plate.

7. The method of producing a display device according to claim 6, wherein
the display panel has a polygonal plan view shape and includes corner portions and side portions on an outer edge of the display panel, and
the holes of the mask plate used in the disposing of the first conductive portions include portions extending along the corner portions and are arranged at intervals along the side portions and accordingly, the first conductive portions including first portions that extend along the corner portions are disposed at intervals along the side portions.

8. The method of producing a display device according to claim 6, further comprising preparing a display panel material member to be separated into multiple parts to be display panels including the display panel, wherein
the mask plate used in the disposing of the first conductive portions has a size so as to overlap the display panel material member and is disposed such that the holes overlap the non-display areas of the display panels.
